(19) United States
(12) Patent Application Publication
(10) Pub. No.: US 2017/0195945 A1
(43) Pub. Date: Jul. 6, 2017

(54) SYSTEMS AND METHODS FOR IDENTIFYING UNMANNED AERIAL VEHICLES

(71) Applicant: The Southern Company, Atlanta, GA (US)

(72) Inventors: Arnold Solomon, Atlanta, GA (US); Marvin Simpson, Atlanta, GA (US)

(21) Appl. No.: 14/985,649

(22) Filed: Dec. 31, 2015

(51) Int. Cl. H04W 48/16; H04L 29/08; H04L 29/12; B64C 39/02; G07C 5/00

(52) U.S. Cl. CPC H04W 48/16; B64C 39/024; G07C 5/008; H04L 61/3075; H04L 67/02; B64C 2201/146; B64C 2201/127; H04W 88/08

(57) ABSTRACT

An exemplary embodiment of the present invention provides a method for identifying an unmanned aerial vehicle (“UAV”), comprising identifying a wireless access point generated by the UAV, the wireless access point having a service set identifier comprising identification information for contacting an operator of the UAV, and contacting the operator of the UAV based on the identification information in the service set identifier.

### TECHNICAL FIELD OF THE INVENTION

The various embodiments of the present disclosure relate generally to identification systems and methods. More particularly, the various embodiments of the present invention are directed to systems and methods for identifying unmanned aerial vehicles (“UAVs”) and operators thereof.

### BACKGROUND OF THE INVENTION

Conventional aircrafts have tail numbers that can be used to identify aircrafts. Based on this identification information, it is possible to determine the operator of the aircraft as well as other information about the aircraft (e.g., purpose of the aircraft, flightplan, etc.) Unmanned Aerial Vehicles (“UAVs”), e.g., drones, however, are typically too small for individual visual identification schemes. Accordingly, it can be difficult, if not impossible, to identify UAVs from the ground. This especially problematic where the UAV has entered sensitive airspace areas (e.g., nuclear power plants, areas with police activity, fires, prisons, sports venues, crime scenes, critical substations, petrochemical manufacturing areas, and confidential/proprietary testing areas). Thus, persons controlling these areas are currently unable to ascertain pilot contact information and pilot licensing information, which can significantly figure into deciding whether a UAV's intentions may be hostile or illegal, such that it should be taken down. Additionally, although many UAVs today must be flown within the line-of-sight of the operator, terrain and various obstacles can make it next to impossible to locate the operator. Further, increasingly popular First Person View (“FPV”), long range 2.4 GHz wireless control, and GPS navigation can facilitate flying a UAV beyond the pilot's line of sight when FAA regulations permit this operation in the future. Therefore, there is a desire for improved systems and methods for identifying a UAV and/or operator thereof. Various embodiments of the present invention address this desire.

### BRIEF SUMMARY OF THE INVENTION

The present invention relates to systems and methods for identifying a UAV. An exemplary embodiment of the present invention provides a method for identifying an unmanned aerial vehicle (“UAV”), comprising identifying a wireless access point generated by the UAV, the wireless access point having a service set identifier comprising identification information for contacting an operator of the UAV, and contacting the operator of the UAV based on the identification information in the service set identifier.

In some embodiments of the present invention, the method further comprises connecting to the wireless access point generated by the UAV.

In some embodiment of the present invention, the method further comprises accessing a splash web page via a captive web portal associated with the wireless access point.

In some embodiments of the present invention, the splash web page comprises one or more of the operator's name, the operator's pilot registration number, the operator's email address, the operator's telephone number, the operator's street address, the UAV's use, the UAV's manufacturer, the UAV's model number, and the UAV's takeoff weight.

In some embodiments of the present invention, the splash web page comprises one or more of a read/write comment section, a photo gallery, UAV performance information, UAV battery level, UAV flight time remaining, current latitude and/or longitude of the UAV, current altitude of the UAV, navigation history of the UAV, elapsed flight time of the UAV, blade RPM of the UAV, UAV camera battery level, UAV camera battery time remaining, and UAV distance from the operator.

In some embodiments of the present invention, the service set identifier comprises a contact telephone number of the operator of the UAV, and contacting the operator of the UAV comprises dialing the telephone number in the service set identifier.

In some embodiments of the present invention, the wireless access point is a WiFi wireless access point.

Another embodiment of the present invention provides a method for allowing the operator of a UAV to be identified, comprising providing access to a wireless access point of the UAV, the wireless access point comprising a service set identifier comprising identification information for contacting an operator of the UAV.

In some embodiments of the present invention, the wireless access point hosts a captive web portal providing access to a splash web page.

In some embodiments of the present invention, the splash web page comprises one or more of the operator's name, the operator's pilot registration number, the operator's email address, the operator's telephone number, the operator's street address, the UAV's use, the UAV's manufacturer, the UAV's model number, and the UAV's takeoff weight.

In some embodiments of the present invention, the splash web page comprises one or more of a read/write comment section, a photo gallery, UAV performance information, UAV battery level, UAV flight time remaining, current latitude and/or longitude of the UAV, current altitude of the UAV, navigation history of the UAV, elapsed flight time of the UAV, blade RPM of the UAV, UAV camera battery level, UAV camera battery time remaining, and UAV distance from the operator.

In some embodiments of the present invention, the service set identifier comprises a contact telephone number of the operator of the UAV.

In some embodiments of the present invention, the wireless access point is a WiFi wireless access point.

Another embodiment of the present invention provides a UAV identification system comprising a UAV comprising a wireless access point having a service set identifier comprising identification information for contacting an operator of the UAV.

In some embodiments of the present invention, the system further comprises a captive web portal associated with the wireless access point, the captive web portal providing access to a splash web page.

In some embodiments of the present invention, the splash web page comprises one or more of the operator's name, the operator's pilot registration number, the operator's email address, the operator's telephone number, the operator's street address, the UAV's use, the UAV's manufacturer, the UAV's model number, and the UAV's takeoff weight.

In some embodiments of the present invention, the splash web page comprises one or more of a read/write comment section, a photo gallery, UAV performance information, UAV battery level, UAV flight time remaining, current latitude and/or longitude of the UAV, current altitude of the UAV, navigation history of the UAV, elapsed flight time of the UAV, blade RPM of the UAV, UAV camera battery level, UAV camera battery time remaining, and UAV distance from the operator.

In some embodiments of the present invention, the service set identifier comprises a contact telephone number of the operator of the UAV.

In some embodiments of the present invention, the wireless access point is a WiFi wireless access point.

Another exemplary embodiment of the present invention provides an application for identifying and/or communicating with an operator of a UAV. The application can be installed and run on a computer, such as a mobile phone or tablet. The application comprises logical instructions stored in a memory of the computer that when executed by a processor of the computer are configured to scan Wi-Fi bands for WAPs, display SSID's of recognized WAPs, and contact an operator of a UAV based on information in an SSID corresponding to a user selected WAP.

In some embodiments, the application further comprises logical instructions that when executed by a processor, are configured to contact the operator of the UAV by dialing a telephone number in the SSID of the user selected WAP.

In some embodiments, the application further comprises logical instructions that when executed by a processor, are configured to contact the operator of the UAV generating a message to be delivered to the operator of the UAV based on a messaging number, e.g., a telephone number, in the SSID of the user selected WAP.

In some embodiments, the application further comprises logical instructions that when executed by a processor, are configured to time stamp and log scanning and/or dialing events to a file to be stored in memory of the computer.

In some embodiments, the application further comprises logical instructions that when executed by a processor, are configured to record a telephone and/or messaging conversation between a user of the application and the operator of the UAV.

These and other aspects of the present invention are described in the Detailed Description of the Invention below and the accompanying figures. Other aspects and features of embodiments of the present invention will become apparent to those of ordinary skill in the art upon reviewing the following description of specific, exemplary embodiments of the present invention in concert with the figures. While features of the present invention may be discussed relative to certain embodiments and figures, all embodiments of the present invention can include one or more of the features discussed herein. Further, while one or more embodiments may be discussed as having certain advantageous features, one or more of such features may also be used with the various embodiments of the invention discussed herein. In similar fashion, while exemplary embodiments may be discussed below as device, system, or method embodiments, it is to be understood that such exemplary embodiments can be implemented in various devices, systems, and methods of the present invention.

### BRIEF DESCRIPTION OF THE DRAWINGS

The following Detailed Description of the Invention is better understood when read in conjunction with the appended drawing. For the purposes of illustration, there is shown in the drawing an exemplary embodiment, but the subject matter is not limited to the specific elements and instrumentalities disclosed.

FIG. 1 provides a UAV identification system, in accordance with an exemplary embodiment of the present invention.

### DETAILED DESCRIPTION OF THE INVENTION

To facilitate an understanding of the principles and features of the present invention, various illustrative embodiments are explained below. The components, steps, and materials described hereinafter as making up various elements of the invention are intended to be illustrative and not restrictive. Many suitable components, steps, and materials that would perform the same or similar functions as the components, steps, and materials described herein are intended to be embraced within the scope of the invention. Such other components, steps, and materials not described herein can include, but are not limited to, similar components or steps that are developed after development of the invention.

As discussed above, conventionally, there does not exist any convenient and reliable manner for persons to identify UAVs and contact the operators thereof to ascertain the intentions of a UAV. Accordingly, various embodiments of the present invention provide systems and methods to allow persons to identify the UAVs and contact the operators thereof. Some embodiments of the present invention can accomplish such a task by allowing the UAV to serve as a wireless access point (“WAP”) with an SSID containing the user's identification and/or contact information.

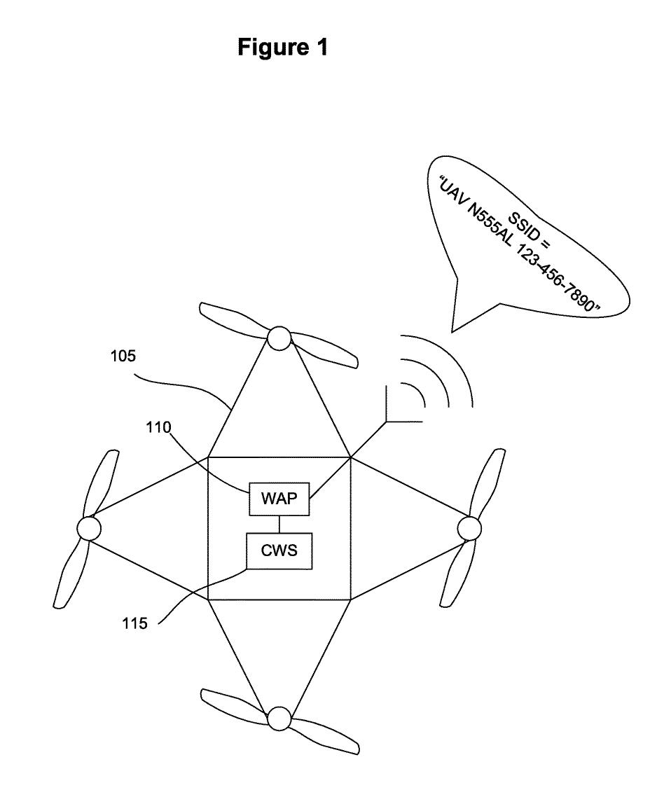

As shown in FIG. 1, an exemplary embodiment of the present invention provides a UAV identification system. The system comprises a UAV 105 comprising a WAP 110 with a service set identifier (“SSID”). In some embodiments of the present invention, the WAP 110 is a WiFi WAP. Thus, for example, the user of a WiFi enabled device can connect to the WAP 110 and see the SSID of the WAP 110. Connection to the WAP 110, however, is not required to see the SSID; rather, SSID's can be seen by, for example, scanning WiFi bands to looks for WAPs that will be identified by an SSID. In some embodiments of the present invention, the SSID contains identification information of an operator of the UAV 105. The SSID can contain many different types of identification information for contacting the operator of the UAV 105. In some embodiments of the present invention, the SSID comprises a telephone number, such as a mobile telephone number of a device used to operate the UAV 105, or of the operator of the UAV 105. For example, the SSID may be “123-456-7890.” In some embodiments, the SSID can comprise the string “UAV” and the operator's telephone number, e.g., “UAV 123-456-7890.” In some embodiments, the SSID can comprise a registration number of the UAV and the operator's telephone number, e.g., “N555AL 123-456-7899.” By including a telephone number of the operator of the UAV, any person with a WiFi enabled device can easily ascertain contact the operator of the UAV by calling the telephone number provided in the SSID, thus allowing the intentions of the UAV to be determined.

The WAP of the UAV can also be associated with a captive web portal 115 that provides access to at least one splash web page. When a WiFi enabled device connects to such a WAP and its user attempts to access a URL address, the user can be automatically redirected to the splash page(s). The splash page(s) can comprise various information related to the UAV and/or the operator of the UAV, such as by providing the information on a single page or containing hyperlinks to subpages with the various information. The splash page(s) can contain, but is not limited to containing, one or more of the following:

Operator of the UAV's mobile telephone number, such as a mobile telephone number of the device used to control the UAV;

Operator of the UAV's landline telephone number;

Instant messaging number/name of the operator of the UAV, such as to the device used to control the UAV;

Operator's name;

Operator's registration number;

AMA registration number;

Operator's flying location (e.g., street address or latitude/longitude);

Operator's mobile email address;

Operator's permanent street address;

Operator's permanent email address;

Operator's local address;

UAV's intended use (e.g, hobby, commercial, government, etc.);

UAV's manufacturer;

UAV's type or model designation;

UAV's takeoff weight;

Read/write comment wall for observers/followers of the UAV;

Photo gallery posted by operator or onboard camera;

UAV's performance information;

Operator's web page (locally hosted or URL);

Operator's blog (locally hosted or URL);

FAA Exception 333 issue number;

FAA Exception 333 designated operating area;

FAA Exception 333 operating terms and conditions;

UAV's battery level;

UAV's Flight time remaining;

UAV's current latitude and/or longitude;

UAV's current altitude;

Downloadable GPS log (latitude, longitude, and altitude) for the UAV;

Navigation track of latitudes, longitudes, and altitudes;

UAV's furthest latitude and/or longitude;

UAV's highest elevation;

UAV's lowest elevation;

UAV's current elapsed flight time;

UAV's current blade rpm;

UAV's current camera battery level;

UAV's current camera battery time remaining;

UAV's current distance from operator (computed);

In addition to the systems described above, the present invention is directed to methods for identifying a UAV. An exemplary embodiment of the present invention provides a method comprising the steps of identifying a WAP generated by a UAV having a SSID comprising identification information for contacting an operator of the UAV, and contacting the operator of the UAV based on the identification information in the SSID.

As discussed above, in some embodiments, the SSID can comprise a telephone number of the operator. In such embodiments, contacting the operator of the UAV can comprise dialing the telephone number in the SSID. These embodiments can allow for direct communication with the operator to ascertain the operator's purpose in operating the UAV a particular area, e.g., to determine if the operator's intentions are hostile.

In some embodiments, the method can further comprise connecting to the WAP of the UAV. In some embodiments, after connecting to the WAP, the method further comprises accessing a splash web page via a captive web portal associated with the WAP. For example, after a user connects to the WAP, the user might open a web browser which automatically directs the user to the splash page(s) where the user can obtain certain information about the UAV or operator thereof. Once on the splash page, the user can obtain one or more of the various pieces of information listed above.

Another embodiment of the present invention provides a method of allowing the operator of a UAV to be identified and/or contacted. The method can comprise providing access to a WAP of the UAV with an SSID comprising identification information for contacting an operator of the UAV. In an exemplary embodiment, the SSID comprises a contact telephone number of the operator of the UAV. In some embodiments, the WAP can be associated with a captive web portal providing access to a splash web page.

In various embodiments of the present invention, the WAP is a WiFi WAP.

While reference is made herein to a captive web portal for providing access to one or more splash web pages containing various information about the UAV and/or operator of the UAV, many different technologies can be used to redirect a user connected to the WAP of a UAV to web pages containing such information. For example, in some embodiments of the present invention, virtual host configuration can be configured in a web server application to allow viewing of various web pages hosted on the UAV containing the various pieces of information listed above.

Another exemplary embodiment of the present invention provides an application that can be installed and run on, for example, a mobile phone, tablet, or computer. When launched, the application can scan both the 2.4 GHz and 5 GHz Wi-Fi bands (or other Wi-Fi bands) looking for WAPs. The application can optionally filter the SSIDs from the recognized WAPs to shows only WAPs with predetermined identification information. The predetermined identification information can include, but is not limited to, one or more of the string “UAV”, the FAA registration number of the UAV, a telephone number of the operator or device controlling the UAV, a messaging number of the operator of the UAV or device controlling the UAV, and an email address of the operator of the UAV or device controlling the UAV. In some embodiments, the application can also includes a contact function that can be used to automatically contact the operator of the UAV based on identified information in a selected SSID. For example, when the user of the application decides which operator to contact by selecting a particular SSID/WAP, simply touching the entry on, e.g., a smartphone, causes the phone to dial the telephone number in the SSID. In some embodiments, scanning and application dialing can be time stamped and logged to a file for forensic analysis. In some embodiments, voice recording functionality can be added for use to record any telephone conversation between the user and the operator of the UAV.

The various methods, systems, and applications discussed herein can be carried out in hardware, software, firmware, and combinations thereof. For example, embodiments of the present invention can include logical instructions stored in one or more known types of memory that when executed by a processor perform the various functions and/or steps described herein.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. Instead, it is intended that the invention is defined by the claims appended hereto.

1. A method for identifying an unmanned aerial vehicle (“UAV”), comprising:
identifying a wireless access point generated by the UAV, the wireless access point having a service set identifier comprising identification information for contacting an operator of the UAV; and
contacting the operator of the UAV based on the identification information in the service set identifier.

2. The method of claim 1, further comprising connecting to the wireless access point generated by the UAV.

3. The method of claim 2, further comprising accessing at least one splash web page via a captive web portal associated with the wireless access point.

4. The method of claim 3, wherein the at least one splash web page comprises one or more of the operator's name, the operator's pilot registration number, the operator's email address, the operator's telephone number, the operator's street address, the UAV's use, the UAV's manufacturer, the UAV's model number, and the UAV's takeoff weight.

5. The method of claim 3, wherein the at least one splash web page comprises one or more of a read/write comment section, a photo gallery, UAV performance information, UAV battery level, UAV flight time remaining, current latitude and/or longitude of the UAV, current altitude of the UAV, navigation history of the UAV, elapsed flight time of the UAV, blade RPM of the UAV, UAV camera battery level, UAV camera battery time remaining, and UAV distance from the operator.

6. The method of claim 1, wherein the service set identifier comprises a contact telephone number of the operator of the UAV, and wherein contacting the operator of the UAV comprises dialing the telephone number in the service set identifier.

7. The method of claim 6, wherein the wireless access point is a WiFi wireless access point.

8. A method for allowing the operator of an unmanned aerial vehicle (“UAV”) to be identified, comprising:
providing access to a wireless access point of the UAV, the wireless access point comprising a service set identifier comprising identification information for contacting an operator of the UAV.

9. The method of claim 8, wherein the wireless access point is associated with a captive web portal providing access to at least one splash web page.

10. The method of claim 9, wherein the at least one splash web page comprises one or more of the operator's name, the operator's pilot registration number, the operator's email address, the operator's telephone number, the operator's street address, the UAV's use, the UAV's manufacturer, the UAV's model number, and the UAV's takeoff weight.

11. The method of claim 9, wherein the at least one splash web page comprises one or more of a read/write comment section, a photo gallery, UAV performance information, UAV battery level, UAV flight time remaining, current latitude and/or longitude of the UAV, current altitude of the UAV, navigation history of the UAV, elapsed flight time of the UAV, blade RPM of the UAV, UAV camera battery level, UAV camera battery time remaining, and UAV distance from the operator.

12. The method of claim 8, wherein the service set identifier comprises a contact telephone number of the operator of the UAV.

13. The method of claim 12, wherein the wireless access point is a WiFi wireless access point.

14. An unmanned aerial vehicle (“UAV”) identification system comprising:
a UAV comprising a wireless access point having a service set identifier comprising identification information for contacting an operator of the UAV.

15. The system of claim 14, further comprising a captive web portal associated with the wireless access point, the captive web portal providing access to at least one splash web page.

16. The system of claim 15, wherein the at least one splash web page comprises one or more of the operator's name, the operator's pilot registration number, the operator's email address, the operator's telephone number, the operator's street address, the UAV's use, the UAV's manufacturer, the UAV's model number, and the UAV's takeoff weight.

17. The system of claim 15, wherein the at least one splash web page comprises one or more of a read/write comment section, a photo gallery, UAV performance information, UAV battery level, UAV flight time remaining, current latitude and/or longitude of the UAV, current altitude of the UAV, navigation history of the UAV, elapsed flight time of the UAV, blade RPM of the UAV, UAV camera battery level, UAV camera battery time remaining, and UAV distance from the operator.

18. The system of claim 14, wherein the service set identifier comprises a contact telephone number of the operator of the UAV.

19. The system of claim 18, wherein the wireless access point is a WiFi wireless access point.

20. The system of claim 14, wherein the service set identifier includes an indicator identifying the wireless access point as being generated by a UAV.
